(19) United States
(12) Patent Application Publication
(10) Pub. No.: US 2026/0234814 A1
(43) Pub. Date: Aug. 13, 2026

(54) COMPOSITE SINTER

(71) Applicant: ITM Power (Trading) Limited, Sheffield (GB)

(72) Inventor: Frederic MARCHAL, Sheffield (GB)

(73) Assignee: ITM Power (Trading) Limited, Sheffield (GB)

(21) Appl. No.: 19/470,924

(22) PCT Filed: Mar. 28, 2024
(86) PCT No.: PCT/GB2024/050881

§ 371 Date: Sep. 30, 2025

(30) Foreign Application Priority Data
Mar. 31, 2023 (GB) 2304879.6

(51) Int. Cl. C25B 11/031; C25B 9/19; C25B 11/056; C25B 11/063

(52) U.S. Cl. CPC C25B 11/031; C25B 9/19; C25B 11/056; C25B 11/063

(57) ABSTRACT

An electrode assembly for REM electrolysis, comprising: a porous sinter plate; a first mesh layer comprising an expanded metal mesh, the first mesh layer having an inner face joined to a face of the porous sinter plate; and, a protective coating applied to the assembly, wherein the first mesh layer is joined to the porous sinter plate at a plurality of point contact regions.

### FIELD OF THE INVENTION

This invention relates to an electrode assembly for Polymer electrolyte membrane (PEM) electrolysis.

### BACKGROUND OF THE INVENTION

The hydrogen industry is widely expected to be a key part of the drive towards decarbonisation and a net-zero emissions economy. Hydrogen can be combined with oxygen to release energy for power, either by burning the hydrogen directly, or within a fuel cell to produce electricity. In both cases, water is produced as a by-product. Hydrogen also has industrial applications, for example in the production of steel and glass, and as a component of many chemical processes. Hydrogen power has the advantages of using proven technology (hydrogen fuel cells were used as far back as the Apollo missions) and producing no greenhouse gases.

Despite being the most abundant element in the universe, hydrogen is not commonly found in commercial quantities on Earth, and must be manufactured. Hydrogen can be produced using PEM (proton exchange membrane) electrolysis. This method is in essence the reverse of a fuel cell. Water is passed through an electrically charged PEM electrode, which splits the water into hydrogen and oxygen. Unlike other methods of hydrogen production, PEM electrolysis does not produce carbon-dioxide or greenhouse gas as a by-product. The membrane is impermeable to gases ensuring safety and is able to self-pressurise gases produced at each electrode. This, however, requires a finely tuned electrode/membrane interface. Additionally, PEM electrolysis can be powered by renewable energy sources such as wind turbines. As a result, PEM electrolysis can be used to produce hydrogen with very low carbon emissions.

PEM electrolysis is typically performed by passing water through an electrochemical cell and applying a direct-current (DC) voltage at two electrodes: a negatively charged cathode and positively charged anode, separated by the gas impermeable proton exchange membrane. Water is oxidised giving protons and oxygen at the anode, the protons are transferred through the proton exchange membrane and are then reduced at the cathode with electrons, producing hydrogen. The protons (positively charged hydrogen ions) pass through the ion transport membrane (a solid polymer electrolyte—PEM) to the cathode, where they combine with electrons to form molecular hydrogen. The molecular hydrogen, in gaseous form, can then be collected at pressure.

However, existing systems and methods for PEM electrolysis have drawbacks. Existing PEM electrolysis assemblies are generally complex multiphase fluid systems and are often corrosion prone and expensive to manufacture and install. Many of these drawbacks represent potential efficiency losses within the system, which can increase the amount of electricity required to produce a unit of hydrogen. Accordingly, there exists a need for PEM electrolysis systems which provide increased efficiency and reduce overall costs.

### SUMMARY OF THE INVENTION

According to a first aspect of the invention, there comprises an electrode assembly for PEM electrolysis, comprising: a porous sinter plate; a first mesh layer comprising an expanded metal mesh, the first mesh layer having an inner face joined to a face of the porous sinter plate; and, a protective coating applied to the assembly, wherein the first mesh layer is joined to the porous sinter plate at a plurality of point contact regions.

Preferably, the assembly comprises a second mesh layer comprising an expanded metal mesh, the second mesh layer having an inner face joined to an outer face of the first mesh layer at a plurality of point contact regions.

Preferably, the first mesh layer and the second mesh layer each comprise one or more crests and a plurality of point contact regions. Preferably, the plurality of point contact regions are located at crests on a face of each respective mesh layer.

Preferably, each of the first mesh layer and the second mesh layer comprise a soft-crest face and a hard-crest face, wherein the crests of the soft-crest faces are softer than the crests of the hard-crest faces; and wherein the first mesh layer and the second mesh layer are joined such that the soft-crest face of the second mesh layer faces outwards.

Preferably, at least one mesh layer comprises: a mesh structure formed by a plurality of strands, and a plurality of diamond-shaped holes defined by the mesh structure, and wherein the diamond-shaped holes have an acute angle at a bond between strands of between 53 and 58 degrees.

Preferably, the point contact regions are located along an edge of a hole defined by the mesh structure of the first mesh layer.

Preferably, the first mesh layer comprises a mesh structure formed by a plurality of strands, and wherein the strands of the first mesh layer have an average thickness between 0.3 and 0.6 mm.

Preferably, at least one of mesh layers has a open volume between 60% and 80% and a minimal frontal opening area of 35%.

Preferably, each of the first and second mesh layers comprises a mesh structure, the mesh structure including a plurality of holes, and wherein when assembled, the plurality of holes in the mesh structure of the first mesh layer are elongate in a first direction, the plurality of holes in the mesh structure of the second mesh layer are elongate in a second direction. Preferably, the first direction and second direction are perpendicular to each other.

Preferably, the flatness of the uppermost and lowermost faces of the electrode assembly is between 0.01 and 0.03 mm per meter.

Preferably, the first mesh layer is joined to one of the second mesh layer and porous sinter plate with a joinery coverage of no less than 15% of the area of the electrode assembly.

Preferably, the electrode assembly further comprises: a third metal mesh layer comprising an expanded metal mesh, the third mesh layer having an inner face joined to the face of the porous sinter plate; and a fourth mesh layer comprising an expanded metal mesh, the fourth mesh layer having an inner face joined to an outer face of the third mesh layer. Preferably, the third and fourth mesh layers are separated from the first and second mesh layers.

Preferably, the porous sinter plate and at least one of the one or more mesh layers comprise titanium.

Preferably, the protective coating comprises platinum or mixed precious metal oxides Preferably, the porous sinter plate comprises a plurality of porous networks.

Preferably, the porous sinter plate comprises a microporous coating formed from at least two different grades of sinter powder.

Preferably, at least one of the one or more mesh layers comprises on a face at least one flow channel.

Preferably, the flow channels have a non-linear geometry.

Preferably, each of the at least one flow channels is a microfluidic flow channel with a diameter perpendicular to the flow direction of less than 750 μm.

Preferably, the electrode assembly has an active area between 1000 and 2100 square centimetres.

Preferably, the electrode assembly has a thickness between 1.1 and 2.8 mm.

According to a second aspect of the invention, there comprises a method for manufacturing an electrode assembly for PEM electrolysis, comprising the steps of: joining an inner face of a first expanded metal mesh layer to a face of a porous sinter plate; and, applying a protective coating to the electrode assembly, wherein the first mesh layer is joined to the porous sinter plate at a plurality of point contact regions.

Preferably, the method further comprises the steps of: joining a second expanded metal mesh layer to an outer face of the first mesh layer; wherein the first mesh layer is joined to the second expanded metal mesh layer at a plurality of point contact regions.

Preferably, the joining of the first expanded metal mesh layer to a face of a porous sinter plate is followed by the joining of the second expanded metal mesh layer to the outer face of the first mesh layer.

Preferably, projection welding is used for the joining of the first mesh layer to the porous sinter plate and the joining of the first mesh layer to the second mesh layer.

### DESCRIPTION OF THE FIGURES

FIG. 1(a) and (b) show views of a schematic of an assembly. FIG. 1(a) is an exploded view, and FIG. 1(b) is a plan view also including the weld head positioning locations.

FIG. 2(a) and 2(b) respectively show portions of the soft-crest and hard-crest faces of a mesh for use in an assembly.

FIG. 3 shows mesh layers overlaid according to an embodiment of the claimed invention.

FIG. 4 is a diagram illustrating the point contact regions between mesh layers in an assembly.

FIG. 5 shows a portion of a component of an assembly including flow channels.

FIG. 6(a), 6(b) and 6(c) show views of a schematic of an assembly. FIG. 6(a) is an exploded view, FIG. 6(b) is a plan view, and FIG. 6(c) is a cross-section through FIG. 6(b) along the line A-A.

FIG. 7 is an exploded view schematic of an assembly including a central gap.

### DESCRIPTION OF THE INVENTION

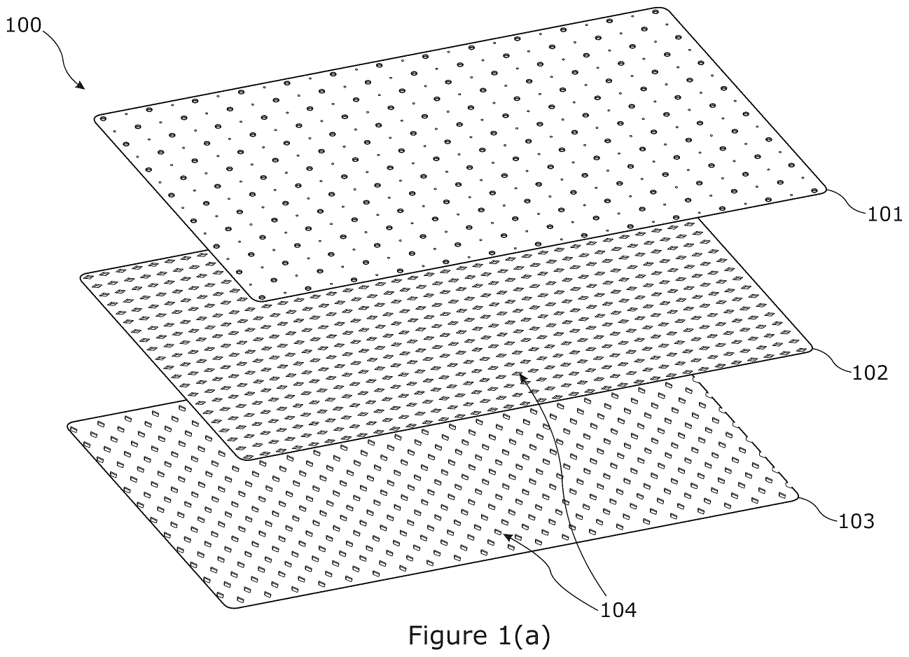

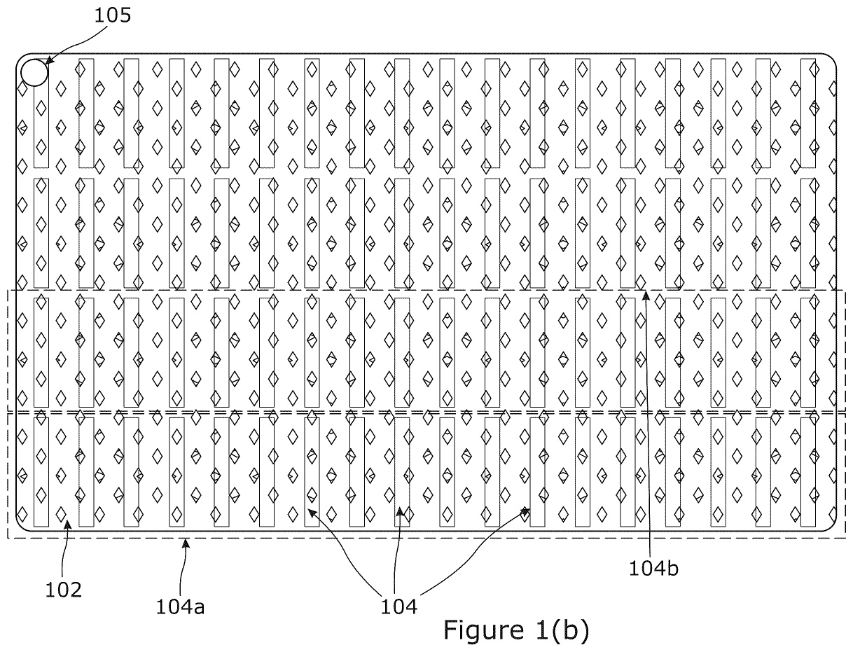

With reference to FIG. 1, an exemplary assembly 100 includes a porous sinter plate 101, a first mesh layer 102 (also known as an inner mesh layer) 102 and a second mesh layer 103 (also known as an outer mesh layer). In alternate embodiments, the assembly 100 may comprise the sinter plate 101 and a first mesh layer 102, with no second mesh layer 103. A single mesh layer 102 is able to direct fluid flow and conduct current as described below, but two or more mesh layers are more effective. The porous sinter plate 101 may comprise a sintered titanium powder material with open cell porosity and containing a plurality of porous networks of different characteristic diameters: large, medium and small. These differently sized porous networks provide different kinds of transport mechanisms through the porous sinter plate 101. For example, the small-diameter porous networks enable capillary transport, while the larger-diameter porous networks enable percolation transport. The porous networks may also carry different substances depending on their size. For example, in the anode electrode, oxygen may be carried towards the PEM membrane by percolation through the large-diameter porous networks, while water is carried away from the PEM membrane by capillary action through the small-diameter porous networks. The pore shapes are either spherical or random and can be fully characterized by those skilled in the art. Apart from physical attributes, geometrical attributes such as length, width and flatness are also stringently controlled in the raw material.

Once assembled, the porous sinter plate 101 and mesh layers 102, 103 are in electrical and non-wet contact with each other and can be used to direct fluid flow and conduct electrical current. The mesh layers 102, 103 are mostly open space (in the region of 60%-80%, with a frontal opening area of at least 35%) providing adequate structural strength and stiffness, without impeding fluid flow and while providing sufficient flow resistance to distribute it well in the cell. “Expanded metal mesh” according to the present disclosure may refer to a metal sheet or foil, which has been sheared without loss of material and then stretched to form a mesh. However, other forms of mesh may conceivably be used, for example meshes made of woven metal wires. The outer face of the porous sinter plate 101 (i.e., the side not joined to the inner mesh layer 102) is pressed against a catalyst layer (not shown), which itself covers the PEM membrane (not shown). The electrolysis reaction takes place at the interface between the porous sinter plate 101 and the catalyst layer.

A porous sinter plate 101 including a plurality of porous networks can be manufactured by combining powders containing differently sized particles, and compacting them to form a sinter. In one example, the powders used have particle sizes ranging from 30 microns to 210 microns in size. The differently sized particles create a plurality of voids of different sizes when nested together, as they do not tesselate in a regular arrangement. The voids link together, providing transport conduits through the porous sinter plate 101.

The porous sinter plate 101 may comprise a microporous coating formed from at least two different grades of sinter powder. Its purpose is to create a greater density of contact points with the PEM membrane, maximising the continuous contact area. A grade of powder refers to its coarseness or fineness. The grade of a powder may be categorised by the smallest nominal mesh aperture size through which the powder could be sieved. In other words, the grade of a powder may indicate an upper limit for the diameter of particles in that powder.

The mesh layers 102 and 103 are formed of expanded metal mesh, and each comprise a plurality of holes 104. The holes 104 may be elongate and diamond/lozenge-shaped as shown. Diamond-shaped holes promote a bi-axial diversion or polarisation of water as it flows through the mesh layers due to differing permeability coefficient in two directions, helping to mix and direct water into all regions of the electrode assembly. Two layers of a same mesh provide a greater flow with less pressure drop. For the purpose of clarity, the mesh layers 102, 103 in FIGS. 1, 6, and 7 are shown as flat sheets with comparatively small holes 104. However, in actuality the mesh layers 102, 103 may have larger holes 104 such that the mesh layers 102, 103 are primarily empty space. Similarly, rather than being flat as shown, the surfaces of the mesh layers 102, 103 may be undulating and comprise crests and troughs. The inner mesh layer 102 may have elongate holes 104 which are elongate in a perpendicular direction to the elongation of the holes in the outer mesh 103, as shown. This arrangement ensures that the mesh layers 102, 103 interfere with each other rather than nest together, which ensures that contact between the layers is only made at point contact regions and over a comparatively small area. Alternatively, nesting between the mesh layers 102, 103 can be prevented by using differently sized or shaped elongate holes in one mesh layer compared to the other mesh layer, such that the crests and troughs of the mesh layers 102, 103 do not align.

In an embodiment, at least one of the porous sinter plate 101, inner mesh layer 102 and outer mesh layer 103 comprise titanium. In some examples, the mesh layers 102, 103 are made of grade 1 titanium mesh. Other titanium alloys may be suitable or desirable such as those containing aluminum, tin, molybdenum, vanadium, zirconium, niobium, or chromium. In some examples, the mesh layers 102, 103 have a 60-80% open volume and a minimal frontal opening area of 35%.

An exemplary method for joining the layers of the assembly is detailed below with reference to FIG. 1(b). The porous sinter plate 101 is held in a jig (porous sinter plate and jig not shown). The inner mesh layer 102 is presented to the porous sinter plate 101 surface and positioned relatively to it with accuracy in the said jig and with the point contact regions preferably in full contact with the porous sinter plate's 101 surface. The jig is moved by a robot under a series of rectangular shaped weld heads arranged in a line and with up to 24 weld heads in a row, so that the weld heads are positioned over a first subset 104a of the weld head positioning locations 104. The weld head positioning locations 104 may be equi-spaced as shown, so as to produce a regular pattern.

The point contact regions of a mesh layer 102, 103 are the regions of a face of that mesh layer which contact another component. The contact regions are “points” in the sense that they have a small width, length, and area. When a mesh layer is joined to another component using welding, the welding current can be concentrated into the small area of a point contact region, resulting in intense but highly localised heating. This is referred to as ‘solid state welding’ as fusion is localised and minimised. The point contact regions can be appropriately sized to concentrate current at discrete points so as to create strong bonds at the point contact regions without locally collapsing the structure of the mesh layer, which could compromise the flatness of the electrode assembly. By minimising the total contact area over the mesh layer, carefully controlling the weld procedure and the power supply, as well as the local contact area at a point contact region, the welding current can be concentrated so as to minimise the diffusion of molten metal. This may reduce the energy required to join the components.

In one embodiment, the weld coverage (i.e., the percentage of the electrode assembly's area viewed in a direction normal to the plane of the mesh layers 102, 103 which is covered by the weld head positioning locations 104) is around 30%-40%. In an embodiment, the area of each weld head (i.e. the area of enclosed by the outline of each weld head positioning location 104) is between 370 m² and 3400 mm², and ideally should be 880 mm². The weld heads may be made out of hard copper or beryllium copper with or without tungsten tips forming a contact with the part.

Once the jig is correctly positioned, the weld heads are moved into contact with the outer face of the inner mesh layer 102 and activated to transfer a welding current. The weld heads may be operated from the same power supply and controlled by a weld head control unit. In order to reduce the constraints on the power supply and the magnitude of currents required, the weld head control unit may, in some examples, activate the weld heads at different times rather than simultaneously. The welding operation is performed, and the jig is then repositioned so that the weld heads are positioned over a second subset 104b of the weld head positioning locations 104. The process is repeated until a sufficient area of the inner mesh layer 102 has been welded to the porous sinter plate 101.

A typical weld sequence consists of at least one hold cycle and at least one weld cycle. During a hold cycle, the two components to be welded are held together, for example using clamps. During a weld cycle, a 50 Hz welding current may be applied between the components. In some examples, the weld intensity during the weld cycles may be between 340 to 1360 A/cm².

Following each weld cycle and/or weld sequence, the welded components may be left to cool for at least one cooling cycle, allowing the weld nuggets to solidify. In general, weld cycles, press cycles and cooling cycles do not overlap. An exemplary weld sequence consists of 4 to 8 hold cycles, interspersed with 2 to 18 weld cycles and 8 cool cycles. Each cycle lasts 20 milliseconds (ms). Typically, between 1 and 3 weld sequences are applied at each weld head positioning location 104. Each weld sequence forms a first set of welds at the point contact regions with the highest resistance. The resistance at the welded point contact regions is reduced by the welds, as the weld nugget itself at the point contact region serves as a conductor. Thus, applying a second weld sequence following a first weld sequence may result in the formation of a second set of welds at the point contact regions now having the highest resistance.

The pattern of welding may be set by using the robot positioner and weld head control unit in combination. The robot positions the weld heads over a subset of the weld head positioning locations 104, and then the weld head control unit activates the weld heads in a particular order. In one embodiment the pattern of welding determined by the robot and weld head works from the centroid of the electrode to the outside of the electrode. In another embodiment the sequence of welding follows a pathway starting from the outside to the inside of the electrode. The pattern and density of welding may differ between anode electrodes and cathode electrodes.

The procedure detailed above may be repeated to join the outer mesh layer 103 to the inner mesh layer 102. In this case, the weld heads would be positioned over weld head positioning locations on the outer face of the outer mesh layer 103. Joining the parts into a single assembly 100 is advantageous because it quickens the process of manufacturing a larger electrolyser apparatus. Rather than inserting each layer of the assembly 100 to the apparatus one by one, the electrode assembly 100 can be handled and inserted in a single step.

Once the porous sinter plate 101 and mesh layers 102, 103 are joined together to form the assembly 100, the protective coating is applied to the assembly 100. The protective layer prevents the naturally occurring titanium oxide layer from growing and compromising the electronic conductivity of the mesh layer. That is, the protective layer protects the electrode and adjoined parts from the cell oxidative conditions and maintains a low resistance for electron transport. This in turn maintains the longevity of the device by preventing oxide growth.

Applying the precious metal protective coating to the assembled electrode 100 may provide a cost saving compared to applying a protective coating to individual components 101-103 before joining. The protective coating may prevent oxide growth on the electrode, which could otherwise impede the electrolysis reaction. A further advantage of coating the assembly after joining is that this type of oxide growth can typically only occur on the external surface of the assembly in contact with water and the PEM, thus the protective coating is applied only to those surfaces that would typically be susceptible to oxidation. Applying the protective coating to the components before fully assembling the assembly would result in at least some of the coating being applied to areas covered over by welding nuggets or trapped between components at the interfaces between joined components. Such areas would not typically be susceptible to oxidation, even if left uncoated, meaning that any protective coating applied to these regions may be redundant. In addition, the energy required for welding a surface that has already been coated with a protective coating may be higher. In some examples where the components were coated before joining, the welding current could cause some of the coating to vaporise, wasting both energy and coating material. Applying the precious metal coating to the assembled electrode (after joining) means that it is applied only to the exposed surfaces of the assembly, thereby decreasing the energy required for welding. The amount of protective coating required may be reduced by approximately 40% by coating the assembly after joining, rather than coating components individually. Protective coating materials according to the present disclosure are typically expensive and so even small material savings may be significant.

The mesh layer is marked with an orientation indicator 105, which may allow an operator or an automated system to determine whether the hard-crest or soft-crest side of the mesh layer is facing towards the operator or system. For example, the orientation indicator 105 may be a pattern of holes punched into a corner of the hard-crest face of the mesh, with the hard-crest face facing towards an operator. If the mesh is orientated in an opposite direction, such that the soft-crest face is facing towards the operator, then the pattern of holes may be found in a different corner from the operator's perspective. This ensures that mesh layers can be quickly and correctly orientated during assembly, including by automated assembly machines.

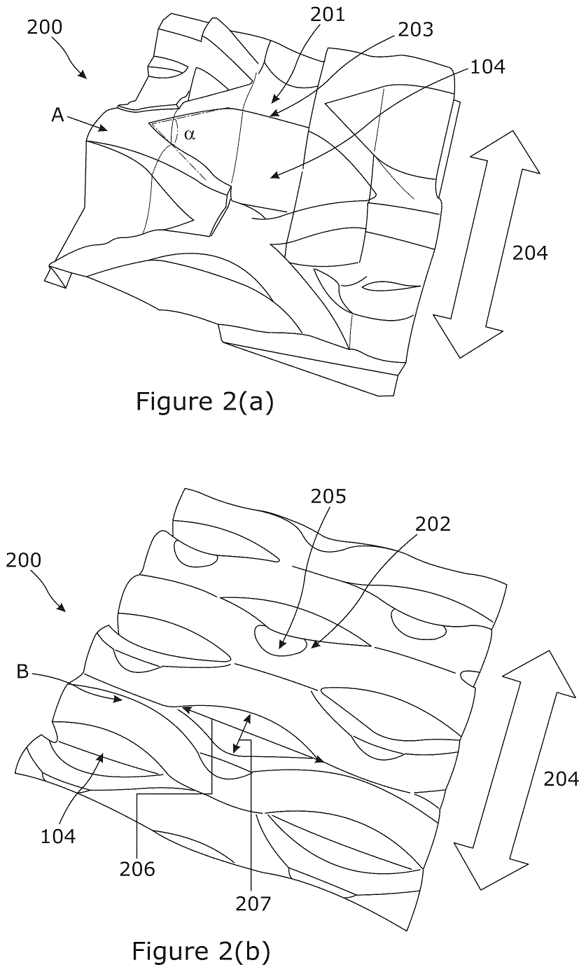

In FIG. 2(a) and 2(b), a detailed three-dimensional view of the faces of an expanded mesh layer 200 is shown. FIG. 2(a) shows face A, and FIG. 2(b) shows face B. The mesh layer 200 is an expanded metal mesh which may be produced by first punching holes 104 in a metal sheet. The sheet is then stretched in a die in the direction indicated by the arrow 204 to expand the holes 104 and thin the metal around the holes into thin strands. In some examples, the thickness of the strands is between 0.3 and 0.6 mm, the strand width is between 0.5 and 0.7 mm. After expansion, the mesh layers are typically between 0.88 and 0.92 mm thick. The holes 104 may be elongate and diamond shaped as shown, such that the length 206 of the holes 104 is greater than their width 207. In an example, the length 206 is 4 mm and the width 207 is 2.2 mm. In an example, the acute angle a at a bond between strands is between 53 and 58 degrees.

Once expanded, a mesh layer 102, 103 may begin to bend due to the coil of the mesh and material. In order to maintain the flatness of the layer and the overall assembly 100, the allowable offset due to bending should be controlled. In some examples, when the mesh layer 102, 103 is laid on a flat surface the vertical offset between the flat surface and any part of the bottom surface of the mesh layer 102, 103 does not exceed a value between 1 and 8 mm. In some examples, the flatness of the outer face of the outer mesh layer 103 is constrained to be between 0.01 and 0.04 mm/m in the welded condition.

The flatness of the outer faces of the electrode assembly 100 may be constrained, to ensure that the electrode can be assembled into a stack with other components. This ensures that multiple electrode assemblies and other components can be stacked together in an electrolyser along a straight line, without deforming one another or leaving voids in between the outermost faces of neighbouring electrode assemblies. It is well known to those skilled in the art that flatness, both localised and electrode-wide, under a constrained state is a necessary pre-requisite to good electrochemistry. In other words the contact between electrode and PEM membrane must be continuous. This is necessary to obtain homogenous reactions, good electron transfer and ionic transfer. An area of electrode not in contact with the PEM membrane or even an area with insufficient contact pressure will not contribute to the reaction that has to be fed locally with current. Poor or inconsistent contact will result not only in reduced efficiency, but may result in current being redirected through neighbouring regions, leading to overloading and excessive wear.

While both faces of the mesh layer 200 may be undulating and may comprise crests and troughs, the illustrated crests 201 of face A (the soft-crest face) have soft, curving ridges 203, whereas the illustrated crests 202 on face B (the hard-crest face) have hard, sharp-edged plateaus 205. These plateaus 205 make the crests 202 of face B harder and sharper-edged than the crests 201 of face A.

As previously discussed, in some examples the expanded metal mesh layer 200 can be produced by punching holes 104 in a metal sheet and then stretching the sheet along the direction 204 to enlarge the holes. The punching process may leave cutting burrs around the edges of the holes 104 on the opposite face (face B) of the sheet to the punched face (face A). When the punched sheet is expanded to form the mesh, the burrs may be stretched into the sharp ridges 203 along the crests 201 of face B.

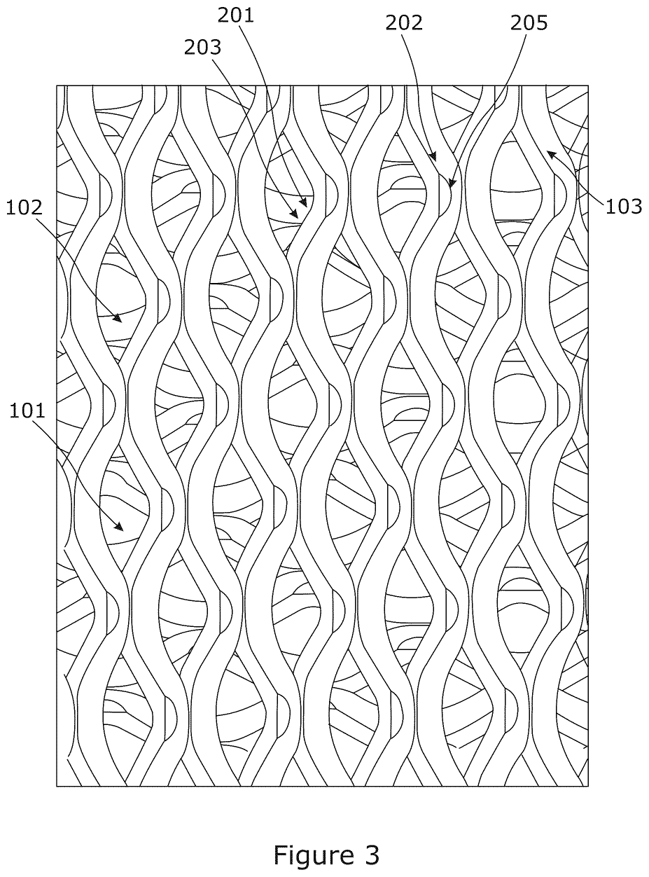

FIG. 3 is a illustrates the stacked components of an assembly from above. In the illustrated assembly, the top is the outer mesh layer 103, underneath which is the inner mesh layer 102. The porous sinter plate 101 can be seen at the bottom. The mesh layers 102, 103 have been joined using solid-state resistance welding leaving no visible weld nuggets. The elongate lengths of the holes 104 in the inner mesh layer 102 and outer mesh layer 103 are perpendicular to each other. As shown in FIG. 3, the assembly 100 can be arranged such that the holes of the mesh layer 102, 103 do not form a repeating geometric pattern. This ensures that the inner 102 and outer 103 mesh layers do not nest together, minimising the total contact area between the mesh layers. Minimising the total contact area also increases current density during welding meaning that a lower welding current is required to join the mesh layers 102, 103.

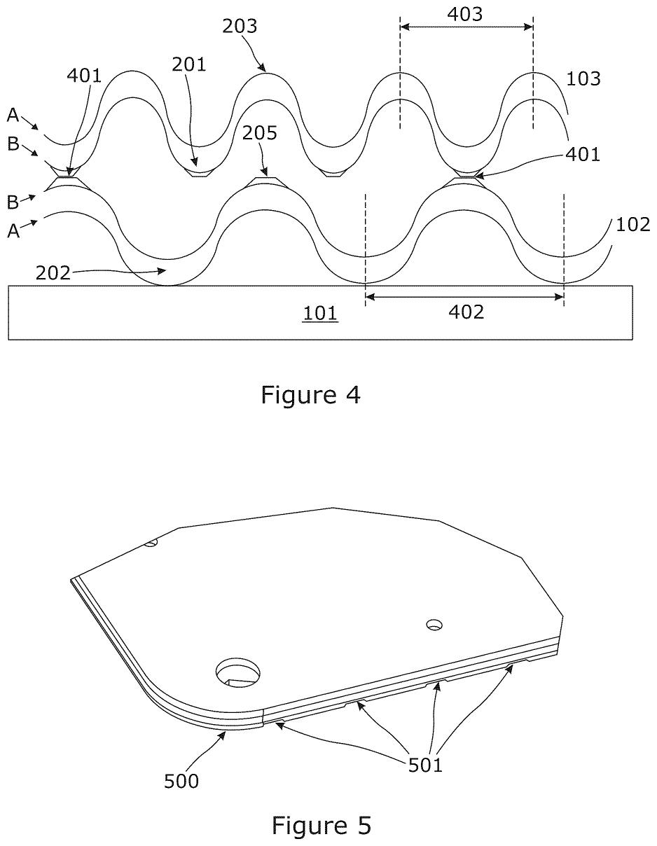

FIG. 4 illustrates an example of how the components of the electrode assembly may be arranged. In the illustrated assembly, the inner 102 and outer 103 mesh layers are arranged so that the soft-crest A face is facing outwards. The crests 201 of the B face on each mesh layer 102, 103 comprise hard, sharp-sided plateau regions 205. The inner mesh layer 102 is shown with its B face as the outer face, such that the mesh layers have an “AB-BA” configuration. Alternatively, the inner mesh layer 103 could be configured such that its A face was the outer face, such that the mesh layers have an “AB-AB” configuration. The inner face of the mesh layer 102 is joined to the porous sinter plate 101.

In some examples, the outer mesh layer 103 may be stacked without nesting (i.e. at a constant elevation) on top of the inner mesh layer 102, by ensuring that the crests of the inner layer 102 do not align with the troughs of the outer mesh layer 103 (and vice versa). In other words, the pitch 402 of the crests on the inner mesh layer 102 along a particular direction should be different to the pitch 403 of the crests on outer mesh layer 103 in the same direction. In the plane of FIG. 4, the crest pitch 402 of the inner mesh layer 102 is shorter than the crest pitch 403 of the outer mesh layer 103. In some examples, this may be achieved by using different crest geometries for the inner 102 and outer 103 mesh layers. Alternatively, as previously discussed and as shown in FIG. 3, the holes 104 in each mesh layer 102, 103 may be arranged such that their elongate lengths 206 are perpendicular to each other. In this arrangement, the ratio of the crest pitch 403 of the outer mesh layer 103 to the crest pitch 402 of the inner mesh layer 102 would be the same as the ratio of the length 206 to width 207 of the holes 104 in the mesh layers 102, 103.

In examples where the inner 102 and outer 103 mesh layers do not nest together, in most places along their B faces the inner mesh layer 102 and outer mesh layer 103 are not in contact. In some examples, the inner mesh layer 102 and outer mesh layer 103 may be configured so that the respective crest pitches 402, 403 are not multiples of each other. In such examples, only a subset of the plateaus 205 of the B face of the inner mesh layers 102, 103 are in contact, as illustrated in FIG. 4. These plateaus 205 serve as point contact regions 401 where an interface is formed between the inner 102 and outer mesh 103 layers.

In an embodiment, projection welding is used to join the mesh layers 102, 103. When a current is passed between the inner mesh layer 102 and outer mesh layer 103, it is concentrated to flow through the point contact regions 401. The high current causes resistance heating at the point contact regions 401, leading to the formation of solid-state weld nuggets that join the mesh layers 102, 103 together at their interfaces. In some examples, the weld nuggets have an indicative size of between 0.1-0.3 mm. In some examples, the contact areas on each mesh layer 102, 103 can be appropriately sized, and the forging pressure and heat input controlled, to concentrate the current at the point contact regions 401 to provide welding without collapsing the local structure of the mesh layers 102, 103, or producing weld expulsions (sudden molten metal emissions away from the weld site). In an example, the mesh layers 102, 103 may be shaped such that the contact area at each point contact region on their soft-crest A side is 0.155 mm², with a length/width ratio of 11.5, and the contact area at each point contact region on their hard-crest B side is 0.149 mm², with a length/width ratio of 8.5.

In some examples, the formation of many weld nuggets increases the total interface area between the mesh layers 102, 103. This decreases the interfacial electronic contact resistance between the parts, leading to increased efficiency and decreased operating costs.

In some examples, the electrode assembly 100 may be assembled by first joining the inner face of the inner mesh layer 102 to a face of the porous sinter plate 101, and then joining the outer face of the inner mesh layer 102 to the inner face of the outer mesh layer 103.

In some examples, the efficiency of the electrolysis reaction may be increased when un-electrolysed water is continually supplied to all areas of the electrode assembly 100 to serve as a reactant and coolant. Lozenge/diamond shaped holes 104 in the mesh may promote a bi-axial diversion of water pumped through the working electrolyser. The shorter dimension 207 of the lozenge may offer more fluid resistance than the long side, as measured via permeability coefficients. This may alter the convection flow of water in the electrode assembly 100 and may act to flood the corners of the assembly 100 preferentially for efficient cooling and reactant water provision in hard to reach areas and to maintain a high stoichiometry ratio. A high stoichiometry ration may be achieved in examples where the flow rate of water provided to all corners of the electrode is greater than the rate at which water is consumed by the electrolysis reaction.

FIG. 5 shows a layer 500 of an electrode assembly 100 comprising a plurality of flow channels 501. in some examples, a flow channel 501 may be an elongate channel formed into the face of a mesh layer, providing a conduit along which fluid can flow unobstructed. The flow channels 501 may further improve and direct fluid flow by directing fluid across the surface of and through the interior of the assembly 100, directing a continuous supply of un-electrolysed water to all regions of the assembly. In some examples, the flow channels may further manage the removal of gases generated from the reaction.

In some examples, the flow channels 501 may extend all the way across the face of a mesh layer to deliver the fluid at discrete positions and in a controllable fashion. Alternatively, the flow channels may only extend part way across the face. in some examples, the flow channels may be located on the outermost layer of the assembly. i.e. the outer face of the outer mesh layer 103. Alternatively, or additionally, other faces of the assembly may comprise flow channels 501, in order to provide conduits for fluid flow through the interior of the assembly.

In some examples, the flow channels 501 May reduce pump losses in the electrode assembly 100, because less pressure may be required to continually pump water into all regions of the assembly 100. The flow channels 501 may extend from the edge of the layer 500 as shown, in order to provide access points and conduit for fluid surrounding the layer 500 to enter and flow through the electrode assembly 100. The flow channels 501 may also provide a route for the gases generated by the electrolysis reaction to escape from the electrode assembly 100. In an example, a mesh layer may include elongate holes, and the flow channels 501 may extend in a direction substantially perpendicular to the elongate direction of the holes. Flow parallel to the shorter dimension of the elongate holes has been found to encounter more fluid resistance than flow parallel to the elongate dimension, as measured via permeability coefficients and practical fluid flow experiments. Thus, orienting the flow channels perpendicular to the elongate direction may help to counteract the increased fluid resistance in this direction.

The flow channels 501 may be formed into the mesh layers 102, 103 during the manufacturing process of the mesh layer. Alternatively, the flow channels 501 may be added after manufacturing. In an example, the flow channels 501 are formed onto the mesh layers 102, 103 using low-tonnage pressing. Alternate methods for forming the channels 501 include pressing, embossing, rolling, or stamping the channels 501 into the mesh layers 102, 103.

In an example, the flow channels 501 may be microfluidic flow channels with a width and/or depth of less than 750 micro metres (μm). In some examples, microfluidic channels and meshes may exhibit hydrodynamic and mechanical advantages over macro-scale fluid channels. In some examples, microfluidic channels may be manufacturable without the use of large tonnage press apparatuses. This may be beneficial as large-tonnage presses can generally only move unidirectionally; by using microfluidic channels a greater and more flexible range of designs and patterns may be formed onto the mesh layers 102, 103.

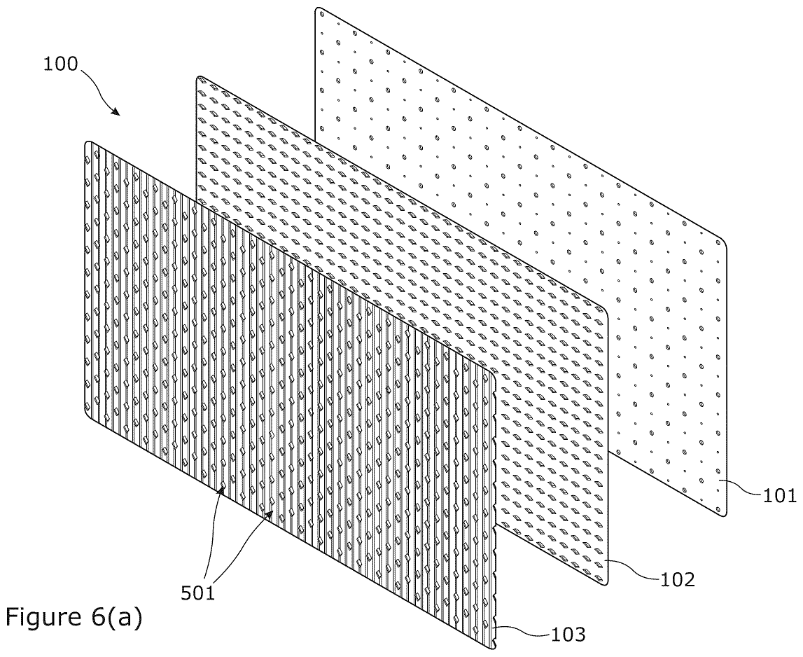

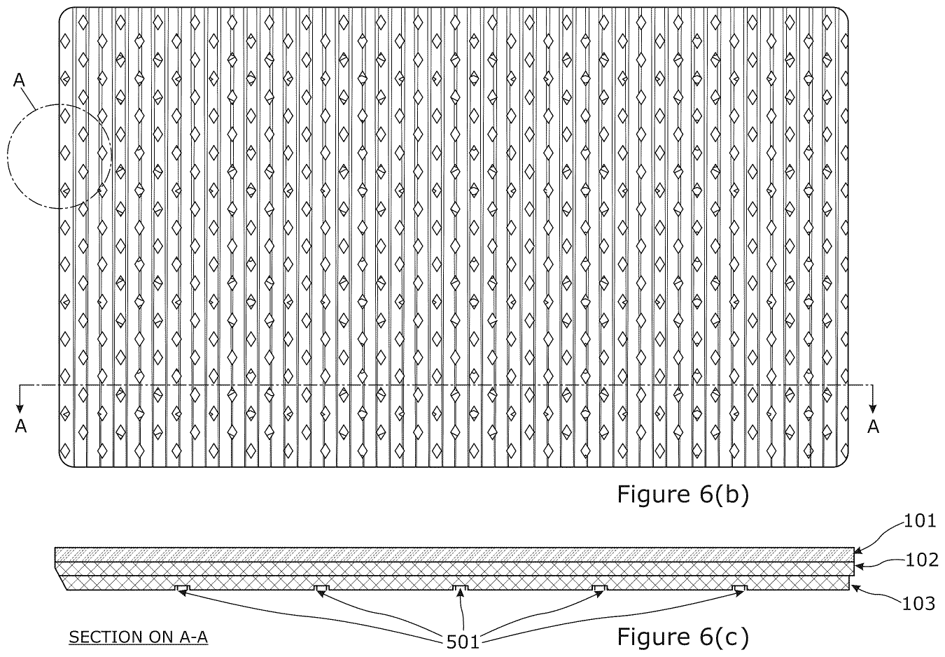

FIG. 6(a) and (b) show views of the configuration of an exemplary electrode assembly 100 incorporating flow channels 501 on the outer face of the outer mesh layer 103. As with FIG. 1, for the purposes of clarity the mesh layers 102 and 103 are shown as flat sheets with small holes in FIG. 6(a) and 6(b). The flow channels are only shown on a single face of a single layer, but in alternate embodiments other surfaces of the electrode array could additionally or alternatively incorporate flow channels 501. The flow channels 501 are shown as straight channels extending from one side of the outer face of the outer mesh layer 103 to the other. Alternatively, the flow channels 501 may have more complex paths and variable cross-sections. For example, the flow channels 501 could curve or change direction, or one or more flow channels 501 could branch into separate channels and/or connect with other flow channels 501.

In an embodiment, the flow channels 501 comprise variable cross sections, the cross section being smaller on the inlet side of the electrode assembly and then becoming larger as the channel 501 nears the outlet side of the electrode assembly where the fluid-gas phase increases. This may allow for a constant velocity of fluid mixed phase and improved microfluidic control. Water electrolysers, contrary to heat exchangers or fuel cells, generally work with mixed phased products. Such flow channels may therefore help to produce a homogeneous coolant/gas distribution and provision to the porous sinter plate 101 in sufficient amount throughout the cell plane, by manipulation of the ratio of speed over resistance to fluid. For example, a flow channel may have a converging-diverging width, creating a venturi tunnel which accelerates flow through a certain region of the mesh layer. Moreover, the variable cross section channels 501 may work in conjunction with mesh layers 102, 103 to create turbulence and eddies that increase the film coefficient more than would occur with straight channels 501. This may further improve effectiveness in removing heat, facilitating a wider operating window with higher current density.

FIG. 6\textcircled{c} illustrates the configuration of the assembly of FIG. 6(b) in section view along the plane A-A. For the purposes of clarity, in FIG. 6(c) the number of the flow channels 501 have been reduced and the scale of each flow channel 501 increased compared to the flow channels 501 shown in FIG. 6(b). The flow channels 501 may have a rectangular cross-section as shown, but other cross sections are also possible. The cross-section may also change in geometry and size along a flow channel 501, or vary between flow channels 501.

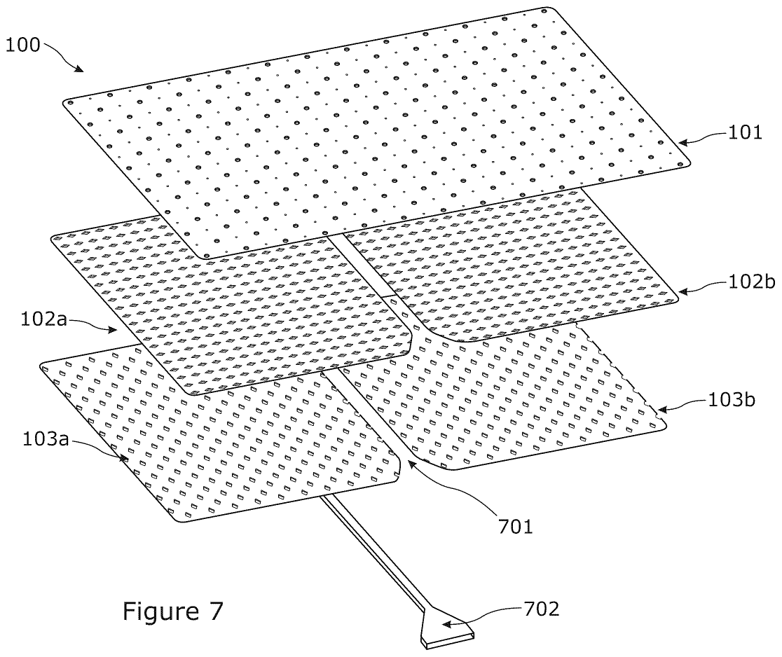

FIG. 7 illustrates an assembly 100 comprising a first inner mesh layer 102a and second inner mesh layer 102b, a first outer mesh layer 103a joined to the first inner mesh layer 102a, and a second outer mesh layer 103b joined to the second inner mesh layer 102b. The first inner mesh layer 102a and first outer mesh layer 103a are separated from the second inner mesh layer 102b and second outer mesh layer 103b by a gap 701. The gap 701 may allow a structural member 702 to be inserted in order to support the porous sinter plate 101 and mesh layers 102, 103, which may improve the stiffness and strength of the assembly 100. In some examples, one or more of the porous sinter plate 101 or mesh layers 102, 103 may be joined to the structural member. The gap 701 may also act as a large flow channel 501, providing a conduit for fluid to flow in and out of the assembly 100. The dimensions of the gap 701 may be greater than those of an inserted structural member to allow fluid to flow through the gap 701 around the structural member.

As with the assemblies 100 comprising a single inner 102 and outer 103 mesh layer, the assembly 100 shown in FIG. 7 may be assembled by first joining the first 102a and second 102b inner mesh layers to the porous sinter plate 101, and then subsequently joining the first 103a and second 103b outer mesh layers to their respective inner mesh layers. The first 102a and second 102b inner mesh layers may be joined to the porous sinter plate 101 sequentially in separate operations, or simultaneously in a joint operation. The first 103a and second 103b outer mesh layers may also be joined to their respective inner mesh layers sequentially in separate operations, or simultaneously in a joint operation.

1. An electrode assembly for PEM electrolysis, comprising:
a porous sinter plate;
a first mesh layer comprising an expanded metal mesh, the first mesh layer having an inner face joined to a face of the porous sinter plate; and, a protective coating applied to the assembly;
wherein the first mesh layer is joined to the porous sinter plate at a plurality of point contact regions.

2. The assembly of claim 1, further comprising a second mesh layer comprising an expanded metal mesh, the second mesh layer having an inner face joined to an outer face of the first mesh layer at a plurality of point contact regions.

3. The assembly of claim 2, wherein the first mesh layer and the second mesh layer each comprise:
one or more crests; and
a plurality of point contact regions;
wherein each of the plurality of point contact regions are located at a crest on a face of each respective mesh layer.

4. The assembly of claim 3, wherein each of the first mesh layer and the second mesh layer comprise a soft-crest face and a hard-crest face, wherein the crests of the soft-crest faces are softer than the crests of the hard-crest faces; and wherein the first mesh layer and the second mesh layer are joined such that the soft-crest face of the second mesh layer faces outwards.

5. The assembly of es claim 1, wherein at least one mesh layer comprises:
a mesh structure formed by a plurality of strands; and
a plurality of diamond-shaped holes defined by the mesh structure, and wherein the diamond-shaped holes have an acute angle at a bond between strands of between 53 and 58 degrees.

6. The assembly of claim 3, wherein each of the point contact regions are located along an edge of a hole defined by the mesh structure of the first mesh layer.

7. The assembly of claim 1, wherein the first mesh layer comprises a mesh structure formed by a plurality of strands, and wherein the strands of the first mesh layer have an average thickness between 0.3 and 0.6 mm.

8. The assembly of claim 1, wherein the first mesh layer has an open volume between 60% and 80% and a frontal opening area of at least 35%.

9. The assembly of claim 2, wherein
each of the first and second mesh layers comprises a mesh structure, the mesh structure including a plurality of holes, and wherein, when assembled:
the plurality of holes in the mesh structure of the first mesh layer are elongate in a first direction;
the plurality of holes in the mesh structure of the second mesh layer are elongate in a second direction; and
the first direction and second direction are perpendicular to each other.

10. The assembly of claim 1, wherein the flatness of the outermost faces of the electrode assembly is between 0.01 and 0.03 mm per meter.

11. The assembly of claim 2, wherein the first mesh layer is joined to one of the second mesh layer and the porous sinter plate with a joinery coverage of no less than 15% of the area of the electrode assembly.

12. The assembly of claim 2, further comprising:
a third metal mesh layer comprising an expanded metal mesh, the third mesh layer having an inner face joined to a face of the porous sinter plate; and
a fourth mesh layer comprising an expanded metal mesh, the fourth mesh layer having an inner face joined to an outer face of the third mesh layer;
wherein the third and fourth mesh layers are separated from the first and second mesh layers.

13. The assembly of claim 1, wherein the porous sinter plate comprises titanium, and wherein at least one of the one or more mesh layers comprise titanium.

14. The assembly of claim 1, wherein the protective coating comprises platinum or mixed precious metal oxides.

15. The assembly of claim 1, wherein the porous sinter plate comprises a plurality of porous networks.

16. The assembly of claim 1, wherein the porous sinter plate comprises a microporous coating formed from at least two different grades of sinter powder.

17. The assembly of claim 1, wherein at least one of the one or more mesh layers comprises, on a face of the mesh layer, at least one flow channel.

18. The assembly of claim 17, wherein one of the at least one flow channels have a non-linear geometry.

19. The assembly of claim 17, wherein each of the at least one flow channels is a microfluidic flow channel with a diameter perpendicular to the flow direction of less than 750 μm.

20. The assembly of claim 1, wherein the electrode assembly has an active area between 1000 and 2100 square centimetres.

21. The assembly of an claim 1, wherein the electrode assembly has a thickness between 1.1 and 2.8 mm.

22. A method for manufacturing an electrode assembly for PEM electrolysis, comprising steps of:
joining an inner face of a first mesh layer comprising an expanded metal mesh to a face of a porous sinter plate to form an electrode assembly; and
applying a protective coating to the electrode assembly;
wherein the first mesh layer is joined to the sinter plate at a plurality of point contact regions.

23. The method of claim 22, further comprising joining a second mesh layer comprising an expanded metal mesh to an outer face of the first mesh layer, wherein the first mesh layer is joined to the second mesh layer at a plurality of point contact regions.

24. The method of claim 22, wherein joining the first mesh layer to a face of a porous sinter plate is followed by joining the second mesh layer to the outer face of the first mesh layer.

25. The method of claims 22, wherein projection welding is used for joining the first mesh layer to the porous sinter plate and joining the first mesh layer to the second mesh layer.
